(19) United States
(12) Patent Application Publication
(10) Pub. No.: US 2025/0387809 A1
(43) Pub. Date: Dec. 25, 2025

(54) LOAD PORT CLEANERS AND OPERATING METHODS THEREOF

(71) Applicant: SAMSUNG ELECTRONICS CO., LTD., Suwon-si (KR)

(72) Inventors: Won Hee LEE, Suwon-si (KR); Shin Hwa JUNG, Suwon-si (KR); Woo Jae KIM, Suwon-si (KR); Joo Sung PARK, Suwon-si (KR); Dae Woo SHIN, Suwon-si (KR)

(21) Appl. No.: 19/001,247

(22) Filed: Dec. 24, 2024

(30) Foreign Application Priority Data
Jun. 19, 2024 (KR) 10-2024-0079309
Sep. 5, 2024 (KR) 10-2024-0120662

(51) Int. Cl. B08B 5/04

(52) U.S. Cl. CPC B08B 5/04; B08B 2205/00

(57) ABSTRACT

A load port cleaner is provided. The load port cleaner comprises a container including a lower plate, an upper plate, and a front plate disposed between the lower plate and the upper plate; first and second lower ports in the lower plate; a first front port in the front plate; a cup installed in the first front port, the cup including an opening exposed to the front, a first connection port, and a second connection port; a first pipe configured to connect the first lower port with the first connection port of the cup; and a second pipe configured to connect the second lower port with the second connection port of the cup.

### CROSS-REFERENCE TO RELATED APPLICATION

This application claims priority under 35 U.S.C. § 119 to Korean Patent Application No. 10-2024-0079309, filed on Jun. 19, 2024, and Korean Patent Application No. 10-2024-0120662, filed on Sep. 5, 2024, in the Korean Intellectual Property Office, the contents of which are herein incorporated by reference in their entirety.

### FIELD

The present disclosure relates to load port cleaners and methods for operating a load port cleaner.

### BACKGROUND

In a semiconductor fabrication plant, three to five load ports are typically provided for each manufacturing facility. The load ports generate particles due to frequent friction with a Front Opening Unified Pod (FOUP). Therefore, regular maintenance of the loads port is required. In practice, cleaning of the load ports is often pushed back due to priority in maintenance work.

### SUMMARY

Embodiments of the present disclosure provide a load port cleaner for periodically cleaning a load port by using a logistics automation system.

Embodiments of the present disclosure provide methods of operating a load port cleaner for periodically cleaning a load port by using a logistics automation system.

Embodiments of the present disclosure are not limited to those mentioned above and additional objects and embodiments of the present disclosure, which are not mentioned herein, will be clearly understood by those skilled in the art from the following description of the present disclosure.

According to some embodiments, a load port cleaner comprises a container including a lower plate, an upper plate, and a front plate disposed between the lower plate and the upper plate; first and second lower ports in the lower plate; a first front port in the front plate; a cup in the first front port, the cup including an opening exposed to the front, a first connection port, and a second connection port; a first pipe configured to connect the first lower port with the first connection port of the cup; and a second pipe configured to connect the second lower port with the second connection port of the cup.

According to some embodiments, a load port cleaner comprises a container including a lower plate, an upper plate, and a front plate disposed between the lower plate and the upper plate; first, second, third and fourth lower ports in the lower plate; first and second front ports in the front plate; a first cup in the first front port, the first cup including a first opening exposed to the front; a second cup in the second front port, the second cup including a second opening exposed to the front; a first pipe connected to the first lower port and the first cup; a second pipe connecting the second lower port with the second cup; a third pipe connecting the first cup with a particle filter; a fourth pipe connecting the second cup with the particle filter; a fifth pipe connecting the particle filter with the third lower port; a vacuum gauge connected to the third and fourth pipes to measure a degree of vacuum in the third and fourth pipes; and a battery supplying power to the vacuum gauge.

According to some embodiments, an operating method of a load port cleaner comprises seating the load port cleaner on a load port, the load port cleaner comprising a container including a lower plate, an upper plate, and a front plate disposed between the lower plate and the upper plate, first and second lower ports in the lower plate, a first front port in the front plate, a cup in the first front port, the cup including an opening exposed to the front, a first pipe configured to connect the first lower port with a first connection port of the cup, and a second pipe configured to connect the second lower port with a second connection port of the cup; wherein the first lower port of the load port cleaner is positioned to correspond to a purge port in a base of the load port; wherein the second lower port of the load port cleaner is positioned to correspond to an exhaust port in the base of the load port; the first front port of the load port cleaner is positioned to correspond to a suction cup in a door opener of the load port, so that the cup and the suction cup are in contact with each other; and providing a purge gas from the purge port, and performing suction in the exhaust port to perform a cleaning operation, the purge gas sequentially passing through the first lower port, the first pipe, the cup, the suction cup, the second pipe and the second lower port and then exiting to the exhaust port.

Details of the other embodiments are included in the detailed description and drawings.

### BRIEF DESCRIPTION OF THE DRAWINGS

The above and other aspects and features of the present disclosure will become more apparent by describing in detail example embodiments thereof with reference to the attached drawings, in which:

FIG. 1 is a conceptual view illustrating a transport system for transporting a load port cleaner according to some embodiments of the present disclosure;

FIG. 2 is a view illustrating a transport device shown in FIG. 1;

FIG. 3 is a perspective view illustrating a load port cleaner according to some embodiments of the present disclosure;

FIG. 4 is a conceptual view illustrating an internal structure of the load port cleaner of FIG. 3;

FIG. 5 illustrates a relationship between a load port cleaner and a load port according to some embodiments of the present disclosure;

FIG. 6 is a perspective view illustrating a load port;

FIG. 7 is a view illustrating a base of the load port of FIG. 6;

FIG. 8 is a view illustrating a door opener of the load port of FIG. 6;

FIG. 9 is a perspective view illustrating an internal structure of a load port cleaner according to some embodiments of the present disclosure;

FIG. 10 is a perspective view illustrating a cup shown in FIG. 9;

FIG. 11 is a view illustrating the cup of FIG. 10, which is viewed from a direction A;

FIG. 12 is a conceptual view illustrating a flushing operation of the cup shown in FIG. 10;

FIG. 13 is a view illustrating a load port cleaner according to some embodiments of the present disclosure;

FIG. 14 is a view illustrating an electrode terminal of the load port cleaner of FIG. 13;

FIG. 15 is a flow chart illustrating methods of operating a load port cleaner according to some embodiments of the present disclosure;

FIG. 16 is a flow chart illustrating methods of operating a load port cleaner according to some embodiments of the present disclosure;

FIG. 17 is a timing view illustrating methods of operating a load port cleaner according to some embodiments of the present disclosure;

FIG. 18 is a conceptual view illustrating a load port cleaner according to some embodiments of the present disclosure;

FIG. 19 is a conceptual view illustrating a load port cleaner according to some embodiments of the present disclosure; and

FIG. 20 is a conceptual view illustrating a load port cleaner according to some embodiments of the present disclosure.

### DETAILED DESCRIPTION OF THE DISCLOSURE

Hereinafter, the embodiments of the present disclosure will be described in detail with reference to the accompanying drawings. The same reference numerals will be used for the same elements on the drawings, and a repeated description of the corresponding elements may be omitted in the interest of brevity.

The terms “comprises,” “comprising,” “includes” and/or “including,” when used herein, specify the presence of stated elements, but do not preclude the presence of additional elements.

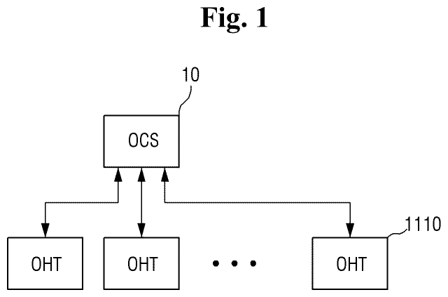

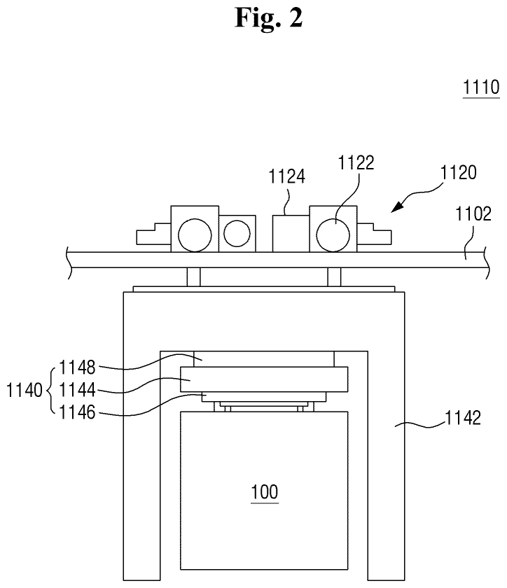

FIG. 1 is a conceptual view illustrating a transport system for transporting a load port cleaner according to some embodiments of the present disclosure. FIG. 2 is a view illustrating a transport device shown in FIG. 1.

First of all, referring to FIG. 1, the transport system includes an OHT control system (OCS) 10 and a plurality of transport devices 1110.

The transport device 1110 may be an overhead hoist transport (OHT) that drives along a rail installed on the ceiling of a semiconductor fabrication plant (i.e., FAB), but is not limited thereto.

The OCS 10 performs communication with the plurality of transport devices 1110 through, for example, a wireless communication mode, and controls the plurality of transport devices 1110. The OCS 10 provides a transport command to each transport device 1110. For example, the transport command may include information such as a start position (Node A), a destination position (Node B), and a transport target load (Load C).

The OCS 10 may allocate a load port to be cleaned by a load port cleaner, which will be described later. By the work assignment of the OCS 10, the transport device 1110 moves the load port cleaner. In addition, the OCS 10 may receive data (e.g., degree of vacuum, data related to a progress process of a cleaning operation, etc.) from the load port cleaner. The OCS 10 may determine a state of the load port (e.g., whether particle cleaning has progressed well), based on the data. The OCS 10 periodically assigns a cleaning work, so that the load port cleaner may clean the load port. When it is necessary to clean the load port every preset period (e.g., 3 months), the OCS 10 sends the load port cleaner to the load port every preset period.

Referring to FIG. 2, the transport device 1110 may transport a transport container such as FOUP accommodating a wafer while moving along a rail 1102 in the semiconductor fabrication plant. Furthermore, the transport device 1110 may transport the load port cleaner according to some embodiments of the present disclosure.

The transport device 1110 includes a housing 1142, a driving module 1120, and a hoist module 1140.

The driving module 1120 is installed on the housing 1142, and is installed to be movable along the rail 1102. The driving module 1120 includes a driving wheel 1122 and a motor 1124 for rotating the driving wheel 1122.

The hoist module 1140 is installed in an inner space of the housing 1142, and ascends and descends while gripping the transport container or load port cleaner 100.

In detail, the hoist module 1140 may include a hoist unit 1144 for ascending and descending the transport container or the load port cleaner 100, a slide unit 1148 for moving the hoist unit 1144 in a left-right direction, and a hand unit 1146 connected to the hoist unit 1144, gripping the transport container or the load port cleaner 100.

A track may be installed on the rail 1102. Power may be supplied to the track, so that the transport device 1110 may be supplied with the power from the track. The transport device 1110 moves by using the supplied power. Alternatively, the supplied power may be charged in a battery inside the transport device 1110.

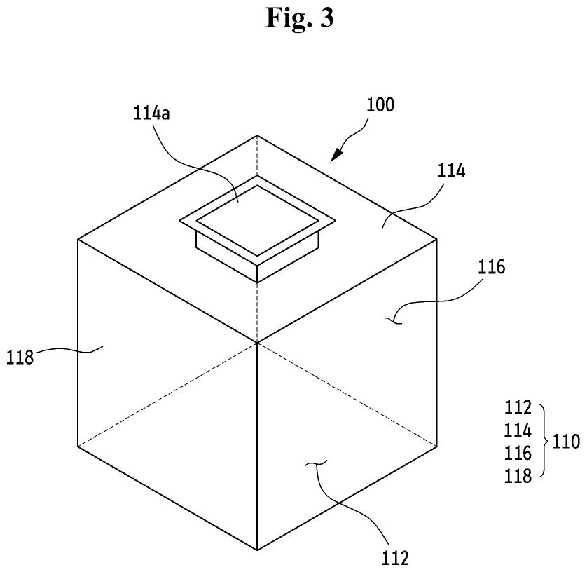

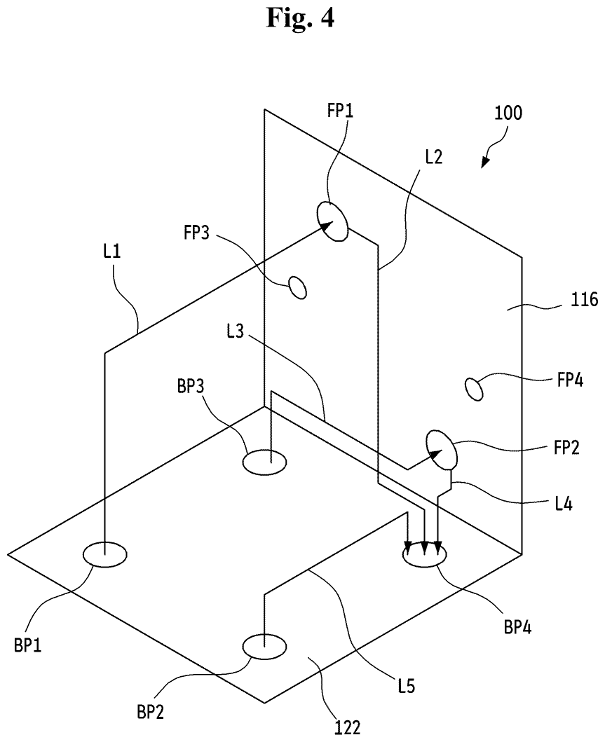

FIG. 3 is a perspective view illustrating a load port cleaner according to some embodiments of the present disclosure. FIG. 4 is a conceptual view illustrating an internal structure of the load port cleaner of FIG. 3.

First, referring to FIG. 3, the load port cleaner 100 includes an enclosure or container 110. The container 110 includes a lower plate 112, an upper plate 114, a front plate 116, and a sidewall plate 118.

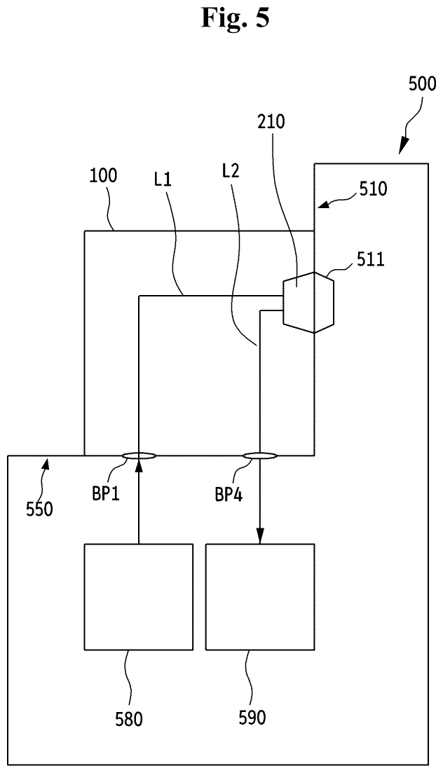

The lower plate 112 and the upper plate 114 are connected to each other by the front plate 116 and the sidewall plate 118. In this case, among the plurality of plates connecting the lower plate 112 with the upper plate 114, the plate configured to face a door opener (see 510 in FIG. 5) of the load port is the front plate 116, and the other plate is the sidewall plate 118.

The lower plate 112 is a plate configured to face a base (see 550 of FIG. 5) of the load port, and the upper plate 114 is a plate configured to face the lower plate 112.

An external appearance shape or exterior shape of the container 110 and an external appearance shape or exterior shape of a semiconductor transport container may be similar to each other so that the container 110 may be moved by the transport device (e.g., OHT) in the semiconductor fabrication plant. The exterior shape of the container 110 may be similar to an exterior shape of, for example, a front opening unified pod (FOUP) or a front opening shipping box (FOSB).

The container 110 may be made of a transparent material. Generally, the semiconductor transport container is made of an opaque material such that a wafer is not affected by light. On the other hand, the load port cleaner 100 may be made of a transparent material such that internal components may be checked from the outside. For example, at least one of the lower plate 112, the upper plate 114, the front plate 116 or the sidewall plate 118 may be made of a transparent material.

A flange 114a is formed on the upper plate 114 of the container 110. The hand unit of the transport device may move the container 110 by gripping the flange 114a.

Referring to FIG. 4, a plurality of lower ports BP1, BP2, BP3 and BP4 are installed or located in the lower plate 112. A plurality of front ports FP1, FP2, FP3 and FP4 are installed or located in the front plate 116.

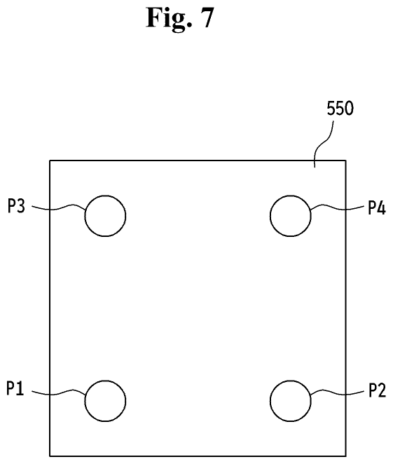

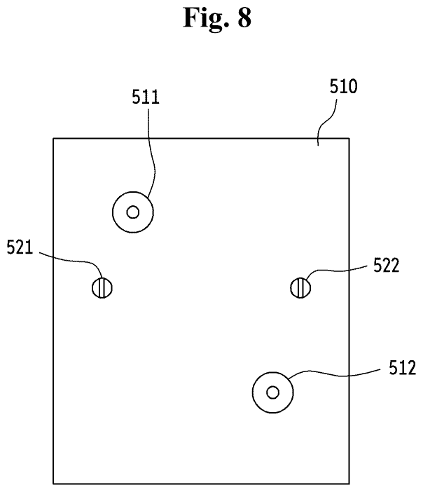

Although described later in detail, in the lower plate 112, the plurality of lower ports BP1, BP2, BP3 and BP4 are located at positions corresponding to a plurality of ports (see P1, P2, P3 and P4 of FIG. 7) of the load port. In the front plate 116, the plurality of front ports FP1, FP2, FP3 and FP4 are located at positions corresponding to suction cups (see 511 and 512 of FIG. 8) of the load port and latch keys (see 521 and 522 of FIG. 8).

A pipe L1 fluidly connects the lower port BP1 with the front port FP1.

A pipe L2 fluidly connects the front port FP1 with the lower port BP4.

A pipe L3 fluidly connects the lower port BP3 with the front port FP2.

A pipe L4 fluidly connects the front port FP2 with the lower port BP4.

In addition, a pipe L5 fluidly connects the lower port BP2 with the lower port BP4.

The load port 500 cleaned by the load port cleaner 100 will be described herein with reference to FIGS. 5 to 8.

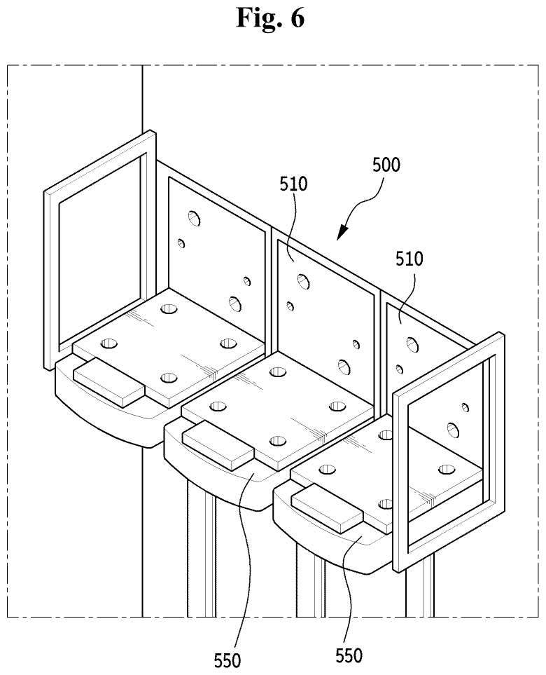

FIG. 5 illustrates a relationship between a load port cleaner and a load port according to some embodiments of the present disclosure. FIG. 6 is a perspective view illustrating a load port. FIG. 7 is a view illustrating a base of the load port of FIG. 6. FIG. 8 is a view illustrating a door opener of the load port of FIG. 6.

Referring to FIGS. 5 to 8, a load port 500 includes a base 550, a door opener 510, a purge gas supplier 580, and a suction device 590. Operations of the door opener 510, the purge gas supplier 580 and the suction device 590 are controlled by a controller.

The plurality of ports P1, P2, P3 and P4 are formed in the base 550. The plurality of ports P1, P2, P3 and P4 may be disposed in accordance with semiconductor standards (i.e., semiconductor equipment and materials international (SEMI) standards), but the present disclosure is not limited thereto. As shown, in the base 550, the ports P1 and P2 may be disposed in parallel with each other, and the ports P3 and P4 may be disposed in parallel with each other.

Each of the plurality of ports P1, P2, P3 and P4 may be a purge port or an exhaust port in accordance with a design. In the present embodiment, the case in which the ports P1, P2 and P3 are purge ports and the port P4 is an exhaust port will be described.

Each of the ports P1, P2 and P3 is fluidly connected to the purge gas supplier 580. The purge gas supplier 580 may supply a purge gas (e.g., N2, Ar, etc.) to the ports P1, P2 and P3. The suction device 590 may form a vacuum to perform an exhaust operation through the port P4.

The inside of the transport container seated on the load port 500 may be flushed by using the purge gas supplier 580 and the suction device 590. That is, when a reactive gas remains in the transport container, an undesired reaction between the reactive gas and the wafer continues. Accordingly, the purge gas supplier 580 may flush the inside of a reaction container by supplying the purge gas to the inside of the reaction container and exhausting the purge gas through the suction device 590. Also, as will be described later, the load port cleaner 100 is connected to the purge gas supplier 580 and the suction device 590 to clean the load port 500.

The door opener 510 is installed substantially perpendicular to the base 550. The door opener 510 is configured to open a door of the transport container.

The door opener 510 includes at least one suction cup 511 or 512 and at least one latch key 521 or 522. The suction cups 511 and 512 and the latch keys 521 and 522 may be disposed in accordance with the semiconductor standards, but the present disclosure is not limited thereto. As shown, in the door opener 510, the latch keys 521 and 522 may be disposed in parallel with each other, and the suction cups 511 and 512 may be disposed diagonally with each other.

The latch keys 521 and 522 are rotatable. The latch keys 521 and 522 are inserted into a latch hole of the transport container and then rotated to open the door of the transport container. The suction cups 511 and 512 are in direct contact with the door of the transport container to hold the door.

In summary, when the transport container is seated on the load port 500, the latch keys 521 and 522 open the door of the transport container while the suction cups 511 and 512 hold the door of the transport container. Then, while the suction cups 511 and 512 hold the door of the transport container, the door opener 510 moves downward to move the door of the transport container.

Since the suction cups 511 and 512 are in direct contact with the door of the transport container, many particles may be generated in and around the suction cups 511 and 512.

When the load port cleaner 100 according to some embodiments of the present disclosure is used, the load port 500 may be cleaned even though an additional device is not installed in the load port 500. That is, the suction cups 511 and 512 of the load port 500 and their surroundings may be cleaned using the purge gas supplier 580 and the suction device 590, which are already installed in the load port 500.

In this case, referring to FIGS. 4 and 5, for cleaning the load port 500, the load port cleaner 100 is seated on the load port 500. The seated load port cleaner 100 is fluidly connected to the purge gas supplier 580 and the suction device 590.

In detail, the plurality of lower ports BP1, BP2, BP3 and BP4 of the load port cleaner 100 overlap the plurality of ports (see P1, P2, P3 and P4 of FIG. 7) located in the base 550 of the load port 500. The plurality of front ports FP1, FP2, FP3 and FP4 of the load port cleaner 100 overlap the suction cups (see 511 and 512 of FIG. 8) and the latch keys (see 521 and 522 of FIG. 8) installed in the door opener 510 of the load port 500.

In addition, as shown in FIG. 5, the front port (e.g., FP1) is provided with a cup 210 having an opening exposed to the front. The cup 210 may come into contact with a corresponding suction cup (e.g., 511) to seal a space between the cup 210 and the suction cup 511.

The purge gas supplier 580 supplies the purge gas through a port (e.g., P1) and a lower port (e.g., BP1). The suction device 590 may form a vacuum to perform an exhaust operation through the port P4 and the lower port BP4.

In more detail, referring to FIGS. 4 and 5, the purge gas provided by the purge gas supplier 580 sequentially passes through the lower port BP1, the pipe L1, the cup 210, the suction cup 511, the pipe L2 and the lower port BP4, and exits to the port (exhaust port) P4. Through this flow of the purge gas, the suction cup 511 is cleaned and its surrounding particles are exhausted to the port P4.

Furthermore, the purge gas provided by the purge gas supplier 580 sequentially passes through the lower port BP3, the pipe L3, the cup/suction cup (512 of FIG. 8), the pipe L4 and the lower port BP4, and exits to the port (exhaust port) P4. Through this flow of the purge gas, the suction cup 512 is cleaned and its surrounding particles are exhausted to the port P4.

Also, the purge gas provided by the purge gas supplier 580 sequentially passes through the lower port BP2, the pipe L5 and the lower port BP4, and then exits to the port (exhaust port) P4. Through this flow of the purge gas, particles around the port P4 may be purged.

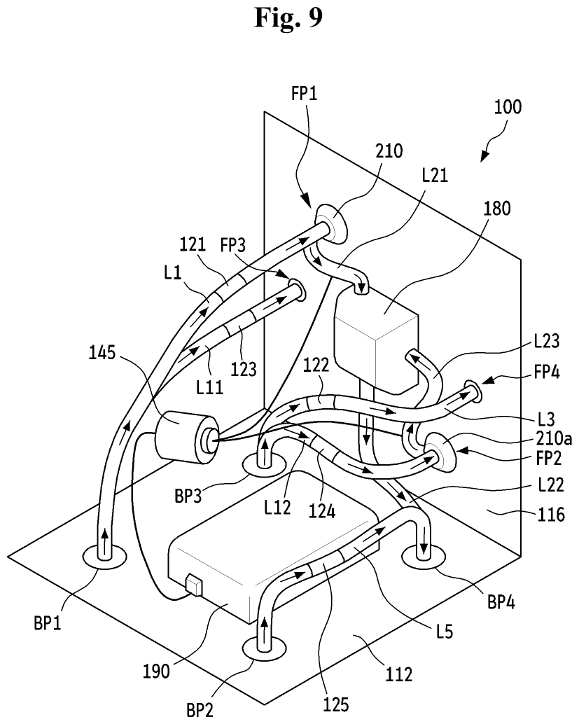

FIGS. 9 to 12 are views illustrating a load port cleaner 100 according to some embodiments of the present disclosure. The load port cleaner 100 shown in FIGS. 9 to 12 is a detailed example of the load port cleaner 100 described with reference to FIG. 4.

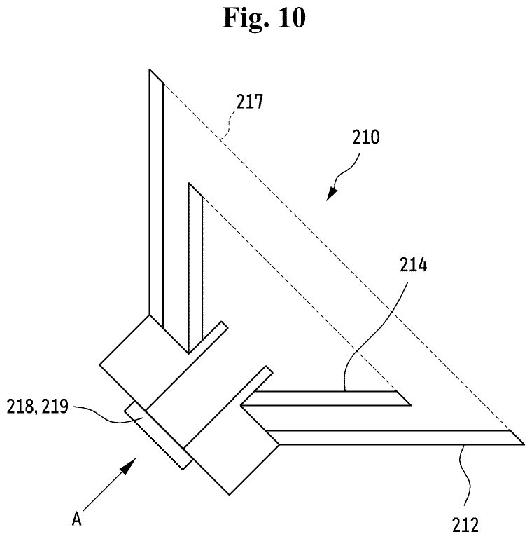

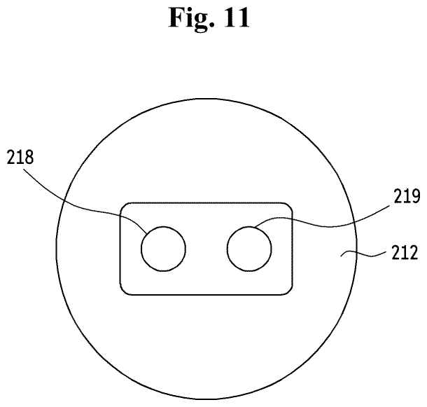

FIG. 9 is a perspective view illustrating an internal structure of a load port cleaner 100 according to some embodiments of the present disclosure. FIG. 10 is a perspective view illustrating a cup 210 shown in FIG. 9. FIG. 11 is a view illustrating the cup 210 of FIG. 10, which is viewed from a direction A. FIG. 12 is a conceptual view illustrating a flushing operation of the cup 210 shown in FIG. 10. For convenience of description, the description will be based on a difference from that described with reference to FIGS. 3 to 8.

First, referring to FIG. 9, the plurality of lower ports BP1, BP2, BP3 and BP4 are installed or located in the lower plate 112. The plurality of front ports FP1, FP2, FP3 and FP4 are installed or located in the front plate 116.

As will be described later, in the lower plate 112, the plurality of lower ports BP1, BP2, BP3 and BP4 are installed or located at positions corresponding to the plurality of ports (see P1, P2, P3 and P4 of FIG. 7) of the load port. In the front plate 116, the plurality of front ports FP1, FP2, FP3 and FP4 are installed or located at positions corresponding to the suction cups (see 511 and 512 of FIG. 8) and the latch keys (see 521 and 522 of FIG. 8) of the load port.

The pipe L1 fluidly connects the lower port BP1 with the front port FP1. A valve 121 is installed in the pipe L1, and the valve 121 may adjust a flow rate of a fluid flowing through the pipe L1. The cup 210 may be installed at an end of the pipe L1, which faces the suction cup (see 511 of FIG. 8). The configuration of the cup 210 will be described later with reference to FIGS. 10 to 12.

A pipe L12 fluidly connects the lower port BP3 with the front port FP2. A valve 124 may be installed in the pipe L12, and the valve 124 may adjust a flow rate of a fluid flowing through the pipe L12. A cup 210a may be installed at an end of a pipe L12, which faces the suction cup (see 512 of FIG. 8). The configuration of the cup 210a is substantially the same as that of the cup 210.

A pipe L21 fluidly connects the front port FP1 with a particle filter 180.

A pipe L23 fluidly connects the front port FP2 with the particle filter 180.

A pipe L22 fluidly connects the particle filter 180 with the lower port BP4.

The pipe L11 fluidly connects the lower port BP1 with the front port FP3. A valve 123 is installed in the pipe L11, and the valve 123 may adjust a flow rate of a fluid flowing through the pipe L11.

The pipe L3 fluidly connects the lower port BP3 with the front port FP4. A valve 122 is installed in the pipe L3, and the valve 122 may adjust a flow rate of a fluid flowing through the pipe L3.

Also, a pipe L5 fluidly connects the lower port BP2 with the lower port BP4. A valve 125 is installed in the pipe L5, and the valve 125 may adjust a flow rate of a fluid flowing through the pipe L5.

The valves 121, 122, 123, 124 and 125 may be needle valves, but are not limited thereto.

A vacuum gauge 145 is connected to the pipes L21 and L23 to measure the degree of vacuum of the pipes L21 and L23.

A battery 190 supplies power to the vacuum gauge 145. While the transport device (e.g., OHT) is gripping and moving the gripped container 110, the battery 190 may be charged by receiving power from the transport device, but is not limited thereto.

Referring to FIGS. 10 and 11, the cup 210 includes a body 212, an opening 217, a plurality of connection ports 218 and 219, and a separation wall 214.

The body 212 may be in the shape of a cone, for example, but is not limited thereto. The body 212 may be in the shape of a cylinder or a right angle cylinder, for example.

The opening 217 is disposed on a first side of the body 212.

The plurality of connection ports 218 and 219 are disposed on a second side of the body 212. For example, the connection port 218 is connected to the pipe L1, and the connection port 219 is connected to the pipe L21.

The separation wall 214 is installed in the body 212. The separation wall 214 may be extended in a direction of the opening 217. For example, the partition wall 214 may be extended in parallel with an outer wall of the body 212. As shown, the separation wall 214 is formed such that it does not protrude beyond the body 212.

Referring to FIG. 12, when the cup 210 and the suction cup 511 are in contact with each other, an inner space of the exposed cup 210 and an inner space of the suction cup 511 are merged with each other, and a sealed and expanded inner space is formed.

A purge gas flows into the body 212 through the connection port 218. The purge gas moves along a flow path between the outer side of the separation wall 214 and the body 212 (see reference numeral R1).

Next, the purge gas separates particles inside the suction cup 511 from the suction cup 511 while colliding with the suction cup 511 (see reference numeral R3).

Subsequently, the purge gas exits to the connection port 219 along the flow path inside the separation wall 214 (see reference numeral R2). The separated particles exit to the connection port 219 together with the purge gas. The purge gas and the particles are transferred to the particle filter 180, and the particles are filtered by the particle filter (180 of FIG. 9).

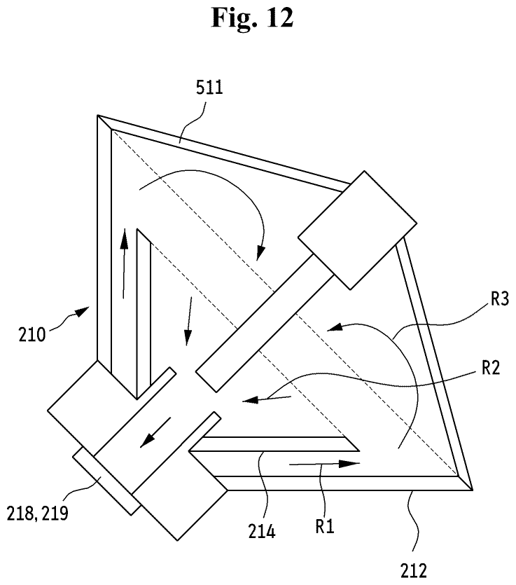

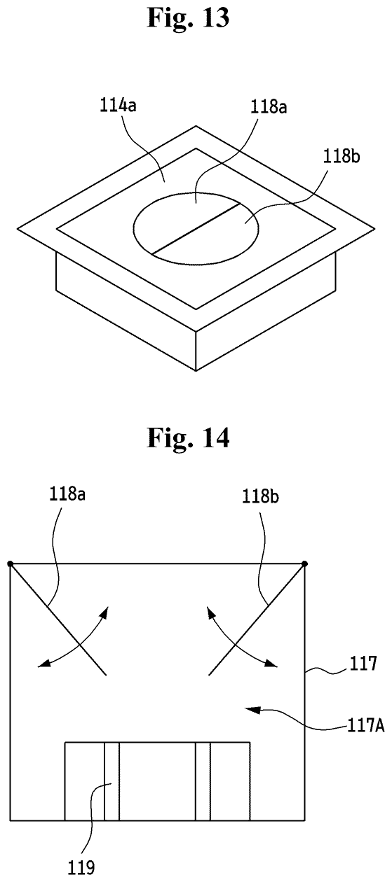

FIG. 13 is a view illustrating a load port cleaner according to some embodiments of the present disclosure. FIG. 14 is a view illustrating an electrode terminal of the load port cleaner of FIG. 13. For convenience of description, the description will be based on differences from those described with reference to FIGS. 3 to 12. In FIG. 13, only the flange 114a of the load port cleaner (100 of FIG. 3) is shown.

Referring to FIGS. 13 and 14, a groove, cavity or slot 117A is formed in the flange 114a of the load port cleaner 100 and may be defined by a partition or wall or walls 117. An electrode terminal 119 is installed in the slot 117A. The electrode terminal 119 is electrically connected to the battery (see 190 of FIG. 9). The slot 117A is provided with covers 118a and 118b. For example, the covers 118a and 118b may be connected to the wall or walls 117 by a hinge.

The covers 118a and 118b are closed when the electrode terminal 119 is not used, and the covers 118a and 118b are opened when the electrode terminal 119 is used.

In detail, when the hand unit of the transport device (see 1110 of FIG. 2) grips the load port cleaner 100, the covers 118a and 118b may be opened while a charging terminal of the transport device 1110 is descending from the top, and the charging terminal of the transport device 1110 may be electrically connected to the electrode terminal 119. The transport device 1110 receives power from a track installed on the rail (see 1102 of FIG. 2), and the transport device 1110 transfers a portion of the received power to the load port cleaner 100. That is, during at least a portion of a time period at which the hand unit of the transport device 1110 grips the flange 114a, the transport device 1110 supplies the power to the load port cleaner 100 through the electrode terminal 119 in the flange 114a, and the supplied power is charged in the battery (see 190 of FIG. 9).

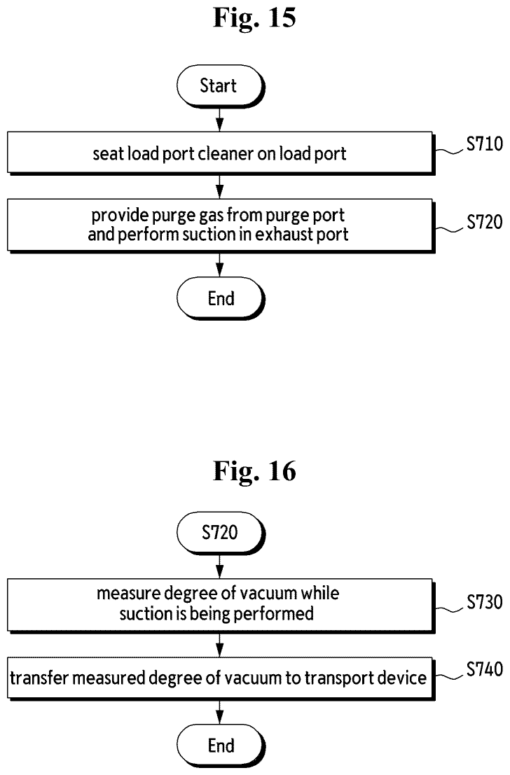

FIG. 15 is a flow chart illustrating an operating method of a load port cleaner according to some embodiments of the present disclosure. For convenience of description, the case that the load port cleaner 100 of FIGS. 9 to 12 is seated on the load port described in FIGS. 3 to 6 and performs a cleaning operation will be described.

Referring to FIG. 15, the transport device seats the load port cleaner 100 on the load port 500 (see S710).

In detail, when the transport device places the load port cleaner 100 on the load port 500, the load port 500 reads an ID tag (for example, RF tag) installed in the load port cleaner 100. When the load port 500 recognizes the load port cleaner 100 by reading the ID tag, the load port 500 and the load port cleaner 100 are docked. As a result, the plurality of lower ports BP1, BP2, BP3 and BP4 of the load port cleaner 100 are positioned to correspond to the plurality of ports (see P1, P2, P3 and P4 of FIG. 7) of the load port. Furthermore, the plurality of front ports (FP1, FP2, FP3 and FP4 of FIG. 9) are positioned to correspond to the suction cups (see 511 and 512 of FIG. 8) and the latch keys (see 521 and 522 of FIG. 8) of the load port.

In the present embodiment, the case in which the ports P1, P2 and P3 are purge ports, and the port P4 is an exhaust port will be described as an example.

Subsequently, the purge gas is provided from the purge port (e.g., P1) of the load port 500, and suction is performed in the exhaust port (e.g., P4) (S720).

In detail, referring to FIGS. 7, 8 and 9, the purge gas provided by the purge gas supplier (see 580 of FIG. 5) sequentially passes through the purge port P1, the lower port BP1, the pipe L1, the cup 210/the suction cup 511, the pipe L21, the particle filter 180, the pipe L22 and the lower port BP4, and then exits to the port (exhaust port) P4. In this way, the suction cup 511 and its surrounding particles are cleaned.

Similarly, the purge gas provided by the purge gas supplier 580 sequentially passes through the purge port P3, the lower port BP3, the pipe L12, the cup 210a/the suction cup 512, the pipe L23, the particle filter 180, the pipe L22 and the lower port BP4, and then exits to the port (exhaust port) P4. In this way, the suction cup 512 and its surrounding particles are cleaned.

In addition, the purge gas provided by the purge gas supplier 580 sequentially passes through the purge port P2, the lower port BP2, the pipe L5 and the lower port BP4, and then exits to the port (exhaust port) P4.

Also, the purge gas provided by the purge gas supplier 580 sequentially passes through the purge port P1, the lower port BP1 and the pipe L11, and then is supplied to the front port FP3. In this way, the latch key 521 is cleaned and its surrounding particles are flushed.

Further, the purge gas provided by the purge gas supplier 580 sequentially passes through the purge port P3, the lower port BP3 and the pipe L3, and then is supplied to the front port FP4. In this way, the latch key 522 is cleaned and its surrounding particles are flushed.

Also, the purge gas provided by the purge gas supplier 580 sequentially passes through the purge port P2, the lower port BP2 and the pipe L5, and then is supplied to the lower port BP4. In this way, the exhaust port P4 facing the lower port BP4 is cleaned and its surrounding particles may be flushed.

As described above, the load port cleaner 100 may clean the load port 500.

FIG. 16 is a flow chart illustrating an operating method of a load port cleaner according to some embodiments of the present disclosure. For convenience of description, contents substantially the same as those described with reference to FIG. 15 will be omitted.

Referring to FIG. 16, after the cleaning operation (S720) is completed, the result of the cleaning is checked. That is, the degree of vacuum is measured while only suction is being performed at the exhaust port (e.g., P4).

In detail, referring to FIGS. 7 to 9, the purge gas supplier 580 does not provide a purge gas and only performs a suction operation at the exhaust port P4. Then, the purge gas supplier 580 measures the degree of vacuum in a preset pipe. For example, the vacuum gauge 145 measures the degree of vacuum in the pipe L21 and/or the pipe L23.

The pipe L21 is directly connected to the front port FP1 (i.e., the cup 210 and the suction cup 511). The pipe L23 is directly connected to the front port FP2 (i.e., the cup 210a and the suction cup 512). Since the vacuum gauge 145 measures the degree of vacuum in the pipes L21 and L23 directly connected to the suction cups 511 and 512, the measured degree of vacuum may indicate the states of the suction cups 511 and 512. The degree of vacuum in the pipe L21 may indicate whether or not cleaning in the front port FP1 has been properly performed. The degree of vacuum in the pipe L23 may indicate whether or not cleaning in the front port FP2 has been properly performed.

Referring to FIG. 16 again, the load port cleaner 100 then transfers or transmits the measured degree of vacuum to the transport device (1110 of FIG. 2) (S740).

In detail, when the load port cleaner 100 transfers or transmits the measured degree of vacuum to the transport device 1110, the transport device 1110 transfers or transmits the measured degree of vacuum to the OCS (see 10 of FIG. 1).

The OCS 10 may store the transferred or transmitted degree of vacuum and check the state of the load port by using the degree of vacuum.

The OCS 10 may determine the state of the suction cups (see 511 and 512 of FIG. 8) through the degree of vacuum in the pipes L21 and L23. That is, when the degree of vacuum satisfies a preset range, it may be determined that the amount of particles in the suction cups 511 and 512 falls within a normal range. When the degree of vacuum satisfies the preset range, it may be determined that the cleaning of the suction cups 511 and 512 is normally performed or operating normally or adequately. When the degree of vacuum satisfies the preset range, it may be determined that the suction function of the suction cups 511 and 512 may be normally performed or operating normally or adequately.

An exemplary method in which the load port cleaner 100 transfers or transmits the measured degree of vacuum to the transport device 1110 will be described as follows.

A data terminal as well as an electrode terminal (119 of FIG. 14) may be further installed in the slot 117A (see FIG. 14) of the flange of the load port cleaner 100.

When the hand unit of the transport device 1110 grips the load port cleaner 110, the charging terminal of the transport device 1110 is connected to the electrode terminal (119 of FIG. 14), and thus a data receiving terminal of the transport device 1110 may be connected to the data terminal of the load port cleaner 100. The measured degree of vacuum is provided to the transport device 1110 through the data terminal/data receiving terminal.

In this case, data related to the progress process of the cleaning operation of the load port cleaner 100 as well as the measured degree of vacuum may be provided or transmitted to the OCS 10 through the transport device 1110.

The data related to the progress process will be described in detail as an example. A timer may be installed in the load port cleaner 100.

When the load port cleaner 100 is seated on the load port 500, the timer starts to operate. A time point at which the cleaning operation starts may be checked through the timer. For example, after the load port cleaner 100 is seated on the load port 500, its cleaning operation may start 7 to 10 seconds later.

Subsequently, the cleaning operation is performed for a preset time (e.g., 35 to 40 seconds), and the cleaning operation is terminated. The time point at which the cleaning operation is terminated is noted through the timer.

Next, the load port 500 unloads the load port cleaner 100. The time point at which the load port cleaner 100 is unloaded is noted through the timer.

The data related to the progress of the process of the above-described cleaning operation may include data indicating a cleaning operation time point, an end time point of the cleaning operation, an unloading time point, and the like.

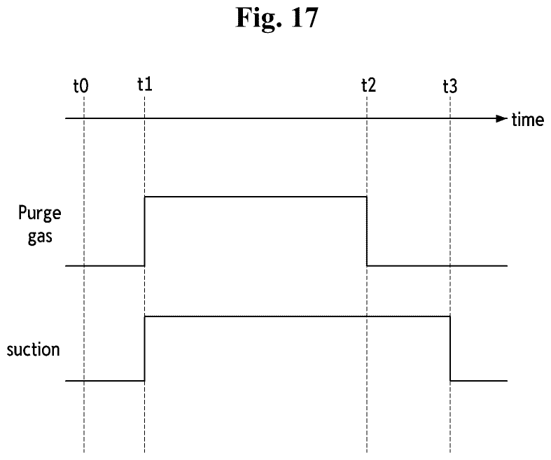

FIG. 17 is a timing view illustrating an operating method of a load port cleaner according to some embodiments of the present disclosure. For convenience of description, the description will be based on differences from those described with reference to FIGS. 15 and 16.

Referring to FIG. 17, at a time period t0, the load port cleaner 100 is seated on the load port 500. For example, when the transport device puts down the load port cleaner 100 on the load port 500, the load port 500 reads an ID tag (for example, RF tag) of the load port cleaner 100. When the load port 500 recognizes the load port cleaner 100 by reading the ID tag, the load port 500 and the load port cleaner 100 are docked.

At a time period t1, the purge gas supplier (580 of FIG. 5) and the suction device (590 of FIG. 5) start to operate, so that the cleaning operation starts. The purge gas supplier 580 may remove or flush particles remaining in the load port 500 by supplying the purge gas into the reaction container and exhausting the purge gas using the suction device 590.

At a time period t2, the cleaning operation ends. The purge gas supplier 580 stops the operation, and the suction device 590 still operates. While the suction device 590 is operating, the vacuum gauge (e.g., 145) measures the degree of vacuum in the preset pipe (e.g., L21 and L23 of FIG. 9).

At a time period t3, the suction device 590 terminates the operation.

Next, the load port 500 and the load port cleaner 100 are undocked.

Subsequently, the transport device 1110 grips and moves the gripped load port cleaner 100.

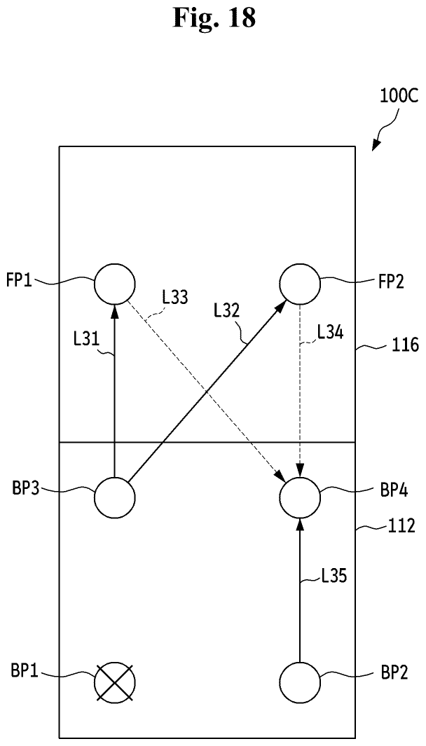

Meanwhile, in FIGS. 3 to 17, the case that the ports P1, P2 and P3 are purge ports and the port P4 is an exhaust port in the load port 500 has been described. In different cases, a method of configuring pipes in the load port cleaner 100 will be described with reference to FIGS. 18 to 20.

FIG. 18 is a conceptual view illustrating a load port cleaner 100C according to some embodiments of the present disclosure. For convenience of description, the description will be based on differences from those described with reference to FIGS. 3 to 17.

FIG. 18 illustrates a case that the port P1 is not used in the load port 500, the ports P2 and P3 are used as purge ports, and the port P4 is used as an exhaust port.

A pipe L31 connecting the lower port BP3 with the front port FP1 and a pipe L32 connecting the lower port BP3 with the front port FP2 are installed in the load port cleaner 100C. Additionally, a pipe L33 connecting the front port FP1 with the lower port BP4 is installed. A pipe L34 connecting the front port FP2 with the lower port BP4 is installed. Also, a pipe L35 connecting the lower port BP2 with the lower port BP4 may be installed. A particle filter (not shown) may be installed in the pipe L33 and/or the pipe L34.

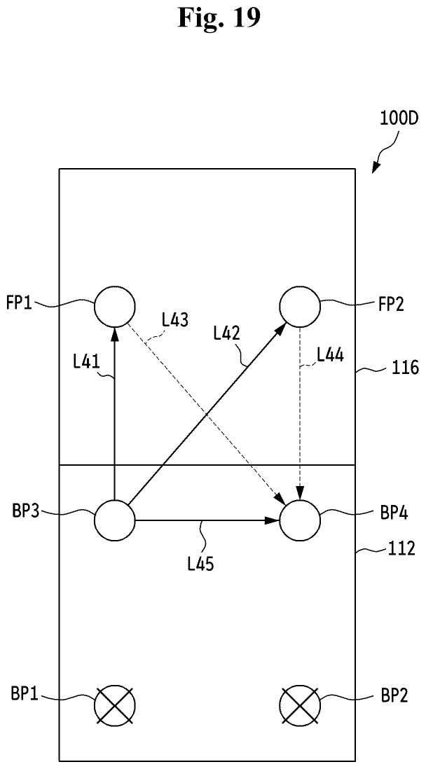

FIG. 19 is a conceptual view illustrating a load port cleaner 100D according to some embodiments of the present disclosure. For convenience of description, the description will be based on a difference from that described with reference to FIGS. 3 to 17.

FIG. 19 illustrates a case that the ports P1 and P2 are not used in the load port 500, the port P3 is used as a purge port, and the port P4 is used as an exhaust port.

A pipe L41 connecting the lower port BP3 with the front port FP1 and a pipe L42 connecting the lower port BP3 with the front port FP2 are installed in the load port cleaner 100D. Additionally, a pipe L43 connecting the front port FP1 with the lower port BP4 is installed. A pipe L44 connecting the front port FP2 with the lower port BP4 is installed. Also, a pipe L45 connecting the lower port BP3 with the lower port BP4 may be installed. A particle filter (not shown) may be installed in the pipe L43 and/or the pipe L44.

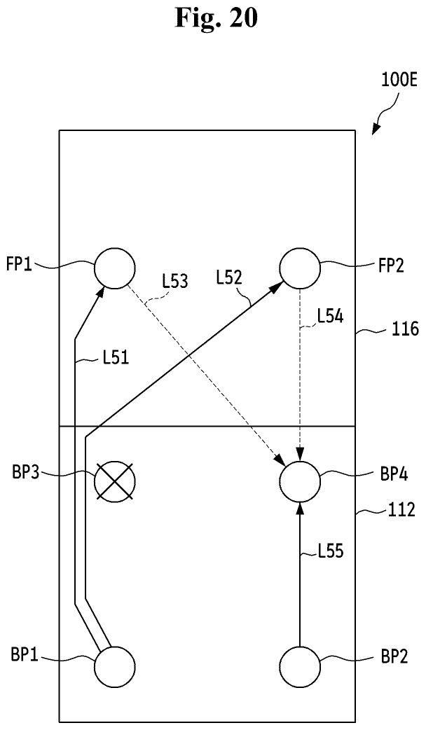

FIG. 20 is a conceptual view illustrating a load port cleaner 100E according to some embodiments of the present disclosure. For convenience of description, the description will be based on a difference from that described with reference to FIGS. 3 to 17.

Referring to FIG. 20, the port P3 is not used in the load port 500, the ports P1 and P2 are used as purge ports, and the port P4 is used as an exhaust port.

A pipe L51 connecting the lower port BP1 with the front port FP1 and a pipe L52 connecting the lower port BP1 with the front port FP2 are installed in the load port cleaner 100E. Additionally, a pipe L53 connecting the front port FP1 with the lower port BP4 is installed. A pipe L54 connecting the front port FP2 with the lower port BP4 is installed. Also, a pipe L55 connecting the lower port BP2 with the lower port BP4 may be installed. A particle filter (not shown) may be installed in the pipe L53 and/or the pipe L54.

Although the embodiments of the present disclosure have been described with reference to the accompanying drawings, it will be apparent to those skilled in the art that the present disclosure can be fabricated in various forms without being limited to the above-described embodiments and can be embodied in other specific forms without departing from technical spirits and essential characteristics of the present disclosure. Thus, the above embodiments are to be considered in all respects as illustrative and not restrictive.

What is claimed is:

1. A load port cleaner comprising:
a container including a lower plate, an upper plate, and a front plate disposed between the lower plate and the upper plate;
first and second lower ports in the lower plate;
a first front port in the front plate;
a cup in the first front port, the cup including:
an opening exposed to the front;
a first connection port; and
a second connection port;
a first pipe configured to connect the first lower port with the first connection port; and
a second pipe configured to connect the second lower port with the second connection port.

2. The load port cleaner of claim 1, wherein:
the first lower port is located at a position corresponding to a first purge port located in a base of a load port;
the second lower port is located at a position corresponding to an exhaust port located in the base of the load port; and
the first front port is located at a position corresponding to a suction cup located in a door opener of the load port.

3. The load port cleaner of claim 1, further comprising:
a second front port in the front plate; and
a third pipe configured to connect the first lower port with the second front port;
wherein the second front port is located at a position corresponding to a latch key in a door opener of a load port.

4. The load port cleaner of claim 1, further comprising:
a third lower port in the lower plate; and
a fourth pipe configured to connect the third lower port with the second lower port;
wherein the third lower port is located at a position corresponding to a second purge port in the base of a load port.

5. The load port cleaner of claim 1, wherein the cup includes:
a body;
the opening disposed on a first side of the body;
the first and second connection ports disposed on a second side of the body; and
a separation wall in the body, wherein the separation wallextends toward the opening.

6. The load port cleaner of claim 1, further comprising a particle filter in the second pipe.

7. The load port cleaner of claim 1, further comprising a vacuum gauge connected to the second pipeto measure a degree of vacuum in the second pipe.

8. The load port cleaner of claim 7, further comprising a battery configured to provide power to the vacuum gauge.

9. The load port cleaner of claim 1, further comprising a flange formed in the upper plate and configured to be gripped by a hand unit of a transport device.

10. The load port cleaner of claim 9, further comprising:
an electrode terminal in the flange; and
a battery electrically connected to the electrode terminal;
wherein the load port cleaner is configured to transfer power from the transport device to the load port cleaner via the electrode terminal to charge the battery while the flange is gripped by the transport device.

11. The load port cleaner of claim 9, further comprising:
a vacuum gauge to measure a degree of vacuum in the second pipe; and
a data terminal in the flange;
wherein the load port cleaner is configured to transmit the degree of vacuum in the second pipe as measured by the vacuum gauge to the transport device through the data terminal.

12. The load port cleaner of claim 1, further comprising a valve in the first pipe to control a flow rate of a fluid flowing through the first pipe.

13. A load port cleaner comprising:
a container including a lower plate, an upper plate, and a front plate disposed between the lower plate and the upper plate;
first, second, third and fourth lower ports in the lower plate;
first and second front ports in the front plate;
a first cup in the first front port, the first cup including a first opening exposed to the front;
a second cup in the second front port, the second cup including a second opening exposed to the front;
a first pipe connected to the first lower port and the first cup;
a second pipe connecting the second lower port with the second cup;
a third pipe connecting the first cup with a particle filter;
a fourth pipe connecting the second cup with the particle filter;
a fifth pipe connecting the particle filter with the third lower port;
a vacuum gauge connected to the third and fourth pipes to measure a degree of vacuum in the third and fourth pipes; and
a battery supplying power to the vacuum gauge.

14. An operating method of a load port cleaner, the operating method comprising:
seating the load port cleaner on a load port, the load port cleaner comprising:
a container including a lower plate, an upper plate, and a front plate disposed between the lower plate and the upper plate;
first and second lower ports in the lower plate;
a first front port in the front plate;
a cup in the first front port, the cup including:
an opening exposed to the front;
a first connection port; and
a second connection port;
a first pipe configured to connect the first lower port with the first connection port; and
a second pipe configured to connect the second lower port with the second connection port;
wherein the first lower port of the load port cleaner is positioned to correspond to a purge port in a base of the load port;
wherein the second lower port of the load port cleaner is positioned to correspond to an exhaust port in the base of the load port;
wherein the first front port of the load port cleaner is positioned to correspond to a suction cup in a door opener of the load port, so that the cup and the suction cup are in contact with each other; and
providing a purge gas from the purge port, and performing suction in the exhaust port to perform a cleaning operation, the purge gas sequentially passing through the first lower port, the first pipe, the cup, the suction cup, the second pipe and the second lower port and then exiting to the exhaust port.

15. The operating method of claim 14, wherein:
the cup includes:
a body;
an opening disposed on a first side of the body;
first and second connection ports disposed on a second side of the body; and
a separation wall in the body and extending toward the opening; and
in the cleaning operation, the purge gas provided from the purge port flows through the first connection port into a space between the cup and the suction cup along one side of the separation wall, and is then discharged through the second connection port along the other side of the separation wall.

16. The operating method of claim 14, wherein:
the load port cleaner further includes a second front port in the front plate and a third pipe configured to connect the first lower port with the second front port;
the second front port is positioned to correspond to a latch key in the door opener of the load port; and
in the cleaning operation, the purge gas is provided from the purge port so that the purge gas is provided to the latch key through the first lower port, the third pipe and the second front port.

17. The operating method of claim 14, wherein:
the load port cleaner further includes a third lower port in the lower plate and a fourth pipe configured to connect the third lower port with the second lower port;
the third lower port is positioned to correspond to a second purge port in the base of the load port; and
in the cleaning operation, the purge gas is provided from the second purge port so that the purge gas is provided to the second lower port through the third lower port and the fourth pipe.

18. The operating method of claim 14, wherein:
the load port cleaner further includes a vacuum gauge connected to the second pipe; and
after the cleaning operation is performed, the vacuum gauge measures a degree of vacuum in the second pipe.

19. The operating method of claim 18, further comprising moving the load port cleaner by gripping the load port cleaner with a transport device after performing the cleaning operation, and transmitting the measured degree of vacuum to the transport device while the transport device is gripping the load port cleaner.

20. The operating method of claim 14, wherein:
the load port cleaner further includes:
a flange formed in the upper plate and configured to be gripped by a hand unit of a transport device;
an electrode terminal in the flange, and
battery electrically connected to the electrode terminal; and
power is transferred from the transport device to the load port cleaner via the electrode terminal to charge the battery while the flange is gripped by the transport device.
